(19) United States
(12) Patent Application Publication
(10) Pub. No.: US 2009/0007408 A1
(43) Pub. Date: Jan. 8, 2009

(54) Apparatus to Assist with Disconnecting Dialysate Tubing

(76) Inventor: Jiandong Sun, San Jose, CA (US)

Correspondence Address: Jiandong Sun, 1649 Merrill Drive #3, San Jose, CA, 95124, US

(21) Appl. No.: 11/774,579

(22) Filed: Jul. 7, 2007

(51) Int. Cl. B23P 19/04

(52) U.S. Cl. 29/221.6

(57) ABSTRACT

This invention relates to an apparatus to be attached to the wall port for dialysate tubing to assist hemodialysis medical staff with disconnecting the dialysate tubing wand from its wall port. The apparatus uses the lever mechanism to minimize the force applied in this procedure and changes the forceful pulling motion to an effortless squeezing of the hand. The apparatus (11) comprises a holder (12) having a round hole (13) through which a wall port can fit snugly and grooves (16) that fit and allow movement of an L-shaped lever (14), an L-shaped lever (14) attaching to the holder (12) via a straight pin (15) that goes through holes (17) on the holder (12) and lever (14), holds the lever (14) and holder (12) together, and forms an axle along which the lever (14) rotates. When the handle of the lever (14) is squeezed, the working end of the lever (14) protrudes out of the holder (12) and pushes out the wand from its attached wall port.

This invention relates to an apparatus to be attached to the wall port for dialysate tubing to assist hemodialysis medical staff with disconnecting the dialysate tubing wand from its wall port. Dialysate tubing refers to the line for dialysate solution to flow from the wall port, through the wand, to the hemodialysis machine.

### BACKGROUND

In every hemodialysis clinic, medical staff needs to prepare a hemodialysis machine for each patient before treatment starts. The process includes disconnecting the dialysate tubing wand from its current wall port, and connecting the wand to the appropriate wall port that dispenses the correct dialysate concentration. It is very important to use the correct dialysate concentration based on the patient's health requirements. Once connected, the dialysate solution flows from the wall port, through the wand, to the hemodialysis machine.

Generally speaking, there are three levels of acid dialysate liquid and one bicarb/alkaline dialysate liquid for hemodialysis. Therefore, there are a total of four wall ports to dispense these four different types of liquid. There are two dialysate tubing lines on the hemodialysis machine, and they connect to the wall ports through wands. One wand stays inserted into the bicarb/alkaline dialysate port and does not need to change place from one treatment to the next. The other wand is inserted into one of three acid dialysate ports, depending on the requirements of each patient. That means the medical staff has to pop out the wand from one of the three acid dialysate ports and then insert it into another port before treating each patient.

The dialysate tubing wand and wall port are constructed to fit tightly together once clicked in. The wand has a C-shape ring that contracts under pressure to form a circle in order to click into a groove on the inside of the wall port. Once clicked in, the ring expands to its original C-shape to lock in the wand. When disconnecting the wand from the port, medical staff must pull hard on the wand to force the C-shaped ring to contract, allowing the wand to pop out of the port. This motion requires significant force because of the locking mechanism, and the force may cause a violent backswing of the elbow.

Because all wall ports are behind a hemodialysis machine and the space within which to move a hemodialysis machine is limited, medical staff has little room to operate the disconnection and connection of the dialysate tubing. The backswing of the elbow while popping a disalysate tubing wand from a wall port often slams into the hemodialysis machine, causing pain and workplace injury.

To operate the current procedure:
1. Move the hemodialysis machine out. Because of limited space in the clinic, the hemodialysis machine can typically only be moved slightly to barely allow a person to reach the wall port;
2. Pull hard on the dialysate tubing wand to pop it out from its current wall port and click it into another wall port, while in a non-ergonomic body position;
3. Move back the hemodialysis machine.

The objective of the present invention is to overcome these problems and to provide a safer and easier way for medical staff to disconnect the dialysate tubing wand from its wall port. The apparatus uses the lever mechanism to minimize the force applied in this procedure and changes the forceful pulling motion to an effortless squeezing of the hand. Once the procedure is complete, the apparatus remains attached to each of the wall ports and is available for repeated use. This apparatus does not affect the construction or function of the dialysate tubing wand and wall port. It attaches to the outside of wall port and assists with the disconnecting procedure to prevent a common workplace injury.

### DETAILED DESCRIPTION

The invention shall be described in more detail in the following with reference to accompanying drawings in which:

FIG. 1 is a side view of the apparatus according to the invention, when it's ready to work;

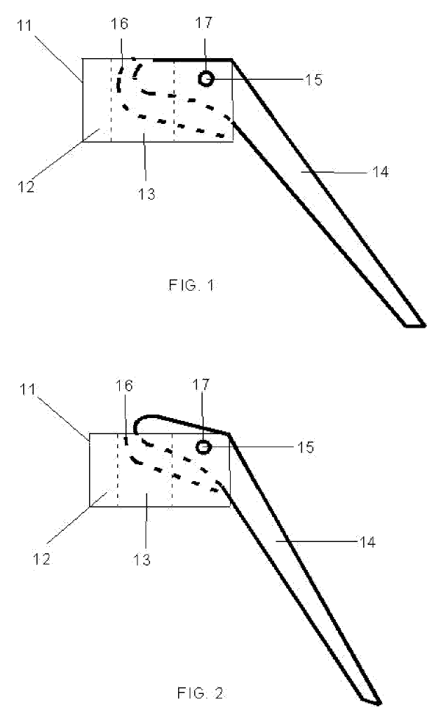

FIG. 2 is a side view of the apparatus illustrating a lever handle being squeezed to protrude the working end of the lever, which pushes out a dialysate wand from its wall port;

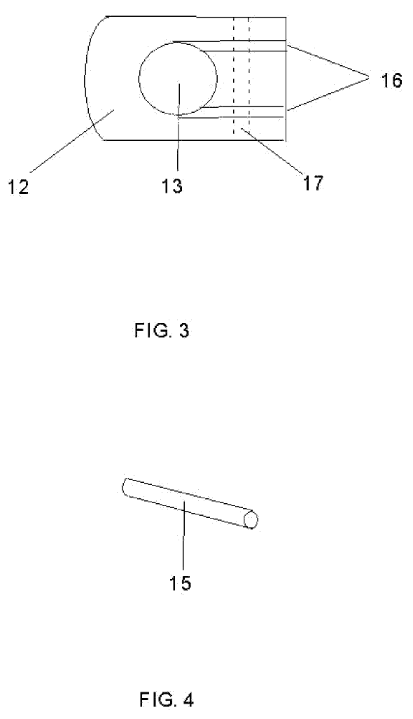

FIG. 3 is a top view of a holder being part of the apparatus;

FIG. 4 is a side view of a straight pin or axle being part of the apparatus;

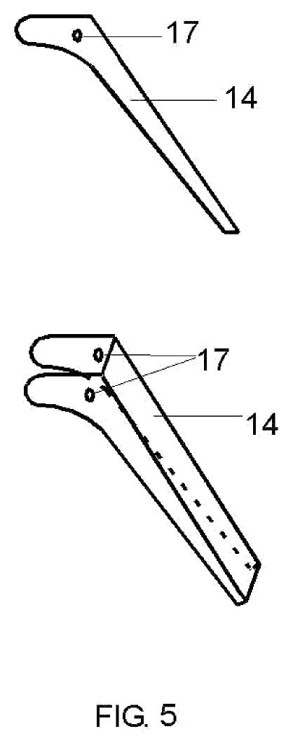

FIG. 5 is a side view and oblique view of a lever being part of the apparatus;

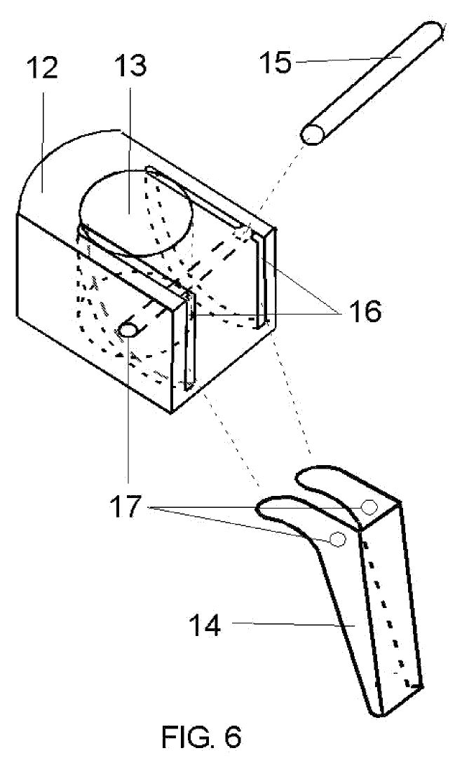

FIG. 6 is an exploded view of the apparatus illustrating how a lever is combined with a holder via a straight pin or axle for the formation of the apparatus shown in FIG. 1;

### DRAWING REFERENCE NUMBER

11. Apparatus to assist with disconnecting dialysate tubing
12. Holder
13. Hole of Holder
14. L-shaped lever
15. Straight Pin or Axle
16. Groove on Holder
17. Small holes on holder and lever, small holes aligned to allow a straight pin through

The apparatus (11) illustrated in the drawings is intended to assist with disconnecting a dialysate tubing wand from its wall port in a hemodialysis clinic. The apparatus (11) substantially comprises a holder (12), an L-shaped lever (14), and a straight pin or axle (15). The holder (12) has a round hole (13) through which a wall port can fit snugly and grooves (16) that fit and allow movement of an L-shaped lever (14). When the apparatus (11) is attached to the wall port, the end of the port extends slightly out of the holder, allowing the port's connection to the dialysate tubing wand to remain unchanged.

The L-shaped lever (14) attaches to the holder (12) via a straight pin or axle (15). The lever (14) has two ends: the handle and the working end. The handle of the lever (14) is at least two times as long as the working end of the lever (14). The working end of the lever (14) has two prongs, one on each side of the inside of the round hole (13) of the holder (12), giving the round hole (13) two straight sides to fit around the wall port perfectly.

The holder (12) and lever (14) have small holes (17) that are aligned to allow a straight pin through. The length of the straight pin (15) is slightly greater than the width of the holder (12), with the pin's (15) two ends enlarged to keep the pin in place. The pin (15) goes through the small holes on the holder (12) and lever (14), holds the holder (12) and lever (14) together, and forms an axle along which the lever rotates.

Operating the apparatus (11) requires one hand to grasp the apparatus (11) and squeeze the handle of the lever (14). When the handle of the lever (14) is squeezed, the working end of the lever (14) protrudes out of the holder (12) and pushes out the dialysate tubing wand from its attached wall port.

The described design uses the lever mechanism to minimize the force applied in disconnecting dialysate tubing wand from its wall port. Because all wall ports for dialysate tubing are of the same external diameter, the apparatus (11) can be used for all such wall ports in hemodialysis clinics.

The apparatus (11) is made of plastic or stainless steel to ensure its sturdiness and allow for repeated use.

I claim:

1. An apparatus to assist with disconnecting a dialysate tubing wand from its wall port in a hemodialysis clinic, said apparatus comprising
a holder having a round hole through which said wall port can fit snugly and grooves that fit and allow movement of an L-shaped lever;
said L-shaped lever attaching to said holder via a straight pin, acting as an axle;
a straight pin that goes through holes on said holder and lever, holds said lever and holder together, and forms an axle along which said lever rotates;
when the handle of said lever is squeezed, the working end of said lever protrudes out of said holder and pushes out the wand from said port.

2. The apparatus of claim 1, wherein said lever is connected to said holder via an axle, the working end of said lever is hidden inside the grooves of said holder when not operating, the working end of said lever protrudes out of the holder when the handle of said lever is squeezed.

3. A method for disconnecting a dialysate tubing wand from its wall port comprising:
(1) attaching an apparatus to a wall port for dialysate tubing, fitting said port snugly through the hole on the holder of said apparatus;
(2) clicking the wand into said port, which is now enclosed in said apparatus, to connect said wand with said port without changing the current procedure;
(3) squeezing the lever handle of said apparatus to protrude the working end of said lever to push out said wand from said port.
